(19) United States
(12) Patent Application Publication
(10) Pub. No.: US 2025/0389645 A1
(43) Pub. Date: Dec. 25, 2025

(54) METHOD AND SYSTEM FOR INSPECTING A PHARMACEUTICAL PRODUCT CONTAINED IN A PACKAGE

(71) Applicants: P.B.L. SRL, Solignano (PR) (IT); SCUOLA NORMALE SUPERIORE, Pisa (PI) (IT)

(72) Inventors: Filippo BEGARANI, Solignano (PR) (IT); Federica SARTORI, Solignano (PR) (IT); Biagio TODARO, Pisa (PI) (IT); Fabio BELTRAM, Pisa (PI) (IT); Stefano LUIN, Pisa (PI) (IT)

(21) Appl. No.: 18/877,476

(22) PCT Filed: Jun. 23, 2023
(86) PCT No.: PCT/IB2023/056514

§ 371 Date: Dec. 20, 2024

(30) Foreign Application Priority Data
Jun. 27, 2022 (IT) 102022000013567

(51) Int. Cl. G01N 21/31; G01N 21/84; G01N 21/90; G01N 21/94

(52) U.S. Cl. CPC G01N 21/31; G01N 21/9027; G01N 21/94; G01N 2021/845; G01N 2201/1296

(57) ABSTRACT

A method for inspecting a pharmaceutical product contained in a package, said method including the steps of: advancing a package of said pharmaceutical product along a transport path; during the advancement of the package along the transport path, subjecting the pharmaceutical product to at least one electromagnetic radiation emitted towards the package, and detecting an optical spectrum generated in response to the impact of the electromagnetic radiation on the pharmaceutical product; performing a spectral analysis of the detected optical spectrum.

### FIELD OF APPLICATION OF THE PRESENT INVENTION

Object of the present invention are a method and system for inspecting a pharmaceutical product contained in a package.

### STATE OF THE ART

Processes for controlling the quality and safety that are customarily used by the pharmaceutical companies to assess the chemical-physical compliance of their products consist in taking a number of samples from their production batch from each step of the manufacturing process. For example, given a batch of 1000 packages of bottles of liquid paracetamol solution, 5 bottles are taken after the filling step, other 5 bottles after the capping step, and additional 5 bottles after the labelling step. The above-mentioned bottles taken from the manufacturing line are subsequently tested in the lab, following the instructions and specifications reported in documents that function as guidelines, and often edited by the authorities in charge. Examples of these documents are the official Pharmacopoeias of various nations or organizations, or other guidelines that are harmonized and recognized by the authorities in charge according to the nation where the drug of interest is produced and/or marketed. Such guidelines are specific for the type of drug and the processed active ingredient. The most common techniques for a chemical inspection of these products, provided for within said guidelines, consist in a HPLC (High Performance Liquid Chromatography) analysis, analysis via probes for measuring pH, DLS (Dynamic Light Scattering), densimeters, gas chromatographers, and others.

The control processes that are known to the state of the art exhibit a series of drawbacks pointed out herein below.

A first drawback is related to a high duration of the control process and the need to employ qualified personnel, resulting in an increase of the process costs.

A second drawback is that the known controls prevent a precise analysis of every package produced within the batch. Furthermore, in the case of a negative outcome only for one of the expected analyses, the manufacturing company has the obligation to discard the whole production batch.

A further drawback is related to the fact that the analyses by random sampling involve the destruction of the tested packages, since the analyses are characterized by the use of invasive modes.

However, with the present finding it is desired to propose a new and/or alternative solution to the solutions known so far, and in particular it is proposed to obviate one or more of the drawbacks or problems referred to above, and/or to meet one or more of the needs felt in the art, and in particular deducible from the above.

### SUMMARY OF THE INVENTION

Therefore, it is provided a method for inspecting a pharmaceutical product contained in a package in accordance with the attached claim 1.

In this manner, it is possible, at least potentially, to analyse every single package within a significantly less time compared to the known solutions.

According to a different advantageous aspect, a quality control of a non-invasive type can thus be achieved.

A system for inspecting a pharmaceutical product contained in a package in accordance with the attached claim 7 is also provided.

In this manner, it is possible, at least potentially, to analyse every single package within a significantly less time compared to the known solutions.

According to a different advantageous aspect, a quality control of a non-invasive type can thus be achieved.

### BRIEF DESCRIPTION OF THE DRAWINGS

This and other novel aspects, or specific advantageous implementations, are anyhow set forth in the claims cited below, the technical characteristics of which can be found in the following detailed description, illustrating preferred and advantageous embodiments, which are however to be considered as merely exemplary and non-limiting of the finding; said description being given by reference to the attached drawings, in which:

FIG. 1 schematically illustrates a system for inspecting a pharmaceutical product contained in a package, according to the present invention;

FIG. 2 illustrates an exemplary bock diagram of a first implementation form of the control unit of the identification system shown in FIG. 1;

FIG. 3 illustrates an exemplary bock diagram of a second implementation form of the control unit of the identification system shown in FIG. 1.

### DETAILED DESCRIPTION OF PREFERRED IMPLEMENTATIONS OF THE INVENTION

With reference to the figures, a system for inspecting a pharmaceutical product contained in a package 100 is referred to by the number 1.

The pharmaceutical product referred to herein can be either solid, or liquid and gaseous, or it can comprise a mixture of components even in different states.

Anyhow, preferably, the pharmaceutical product is in the form of a solution containing a drug, i.e., preferentially, is in the form of a liquid pharmaceutical product, in particular contained in a corresponding bottle. In particular, the pharmaceutical product is preferably in the form of a paracetamol solution.

By package 100, it is meant herein any object adapted to house the pharmaceutical product in view of the placing on the market. Thus, the term package 100 is not limited to a finished condition, but also encompasses a intermediate condition: for example, a container with the pharmaceutical product therein, but still without a cap. Among the intermediate conditions, the product prior to its insertion into the final container can also be enumerated, in the case it is analysed with techniques similar to those described herein (for example, by exciting and detecting the signal via a lens submerged in the solution containing the drug).

Preferably, as will be anyhow more apparent from the following of the present description, said pharmaceutical product, in particular in the form of a solution containing a drug, is contained in a package or container, preferably in the form of a bottle, which is transparent to a corresponding electromagnetic radiation that is directed towards the pharmaceutical product contained in the same package.

The inspection system 1 comprises means for transporting 2 at least one package 100 along a transport path. Preferably, a plurality of packages is fed along the transport means 2.

In accordance with an implementation form, the transport means 2 comprise one or more conveyor belts.

In accordance with an implementation form, the transport means 2 comprise one or more rotary carousels of gripping means.

In accordance with an implementation form, the transport means 2 comprise at least one conveyor belt and at least one rotary carousel.

In any case, those skilled in the art can choose transport means 2 among several possibilities in the known art that are accessible to them.

The inspection system 1 comprises a source 3 of electromagnetic radiations. Such source 3 is configured to emit at least one electromagnetic radiation directed towards the pharmaceutical product contained in the package 100 arranged in a control station R. The control station R is located along the transport path, i.e., along the transport means 2. In other words, the source 3 emits the radiation towards the control station R: the emitted radiation hits at least one package 100 passing through the control station R.

In particular, the source 3 is configured to direct the electromagnetic radiation towards a predetermined control station R along the transport path.

Preferably, the source 3 is a light source. BY way of exemplary, non-limiting example, the source 3 can be of the laser type, a Xenon lamp, a LED, etc.

Preferably, the wavelength of the emitted electromagnetic radiation is within a range from the ultraviolet to the infrared, up to the Terahertz.

In this case, the source 3 emits at least a light beam that impacts the package 100 to be analysed. Such light interacts with the content of the package 100 and, according to the interacting chemical compounds, it will originate optical spectra (henceforth also referred to as “signals”), which are characteristic of the analysed compounds (and the used spectroscopic technique).

The inspection system 1 comprises means for detecting 4 an optical spectrum generated in response to the impact of the electromagnetic radiation on the pharmaceutical product.

Preferably, the detecting means 4 are configured to measure at least one spectrum and convert it into an analog/digital signal.

By way of exemplary, non-limiting example, the detecting means 4 comprise: (i) a system to convey the signal to the spectra detector/analyser (e.g., lenses and/or optomechanical systems, possibly electronically driven), (ii) an optically dispersing member (grating, prism) or which anyhow allows separating the components of the spectrum; (iii) a detector (usually referred to as “detector”), among which, for example, a CCD camera, a CMOS camera, one or more photodiodes or photomultipliers and the corresponding possible system of optics and mechanical or optical mechanisms that are adapted to detect the desired spectrum.

The different components described above can also be (partially or fully) grouped in one or more suitable tools.

The choice of the light source 3, the type of the detector, and the configuration of the optical path between the source 3 and the package 100 to be analysed, and between the latter and the detector, strictly depend on the compounds that are intended to be analysed and the type of information of interest.

The source 3 and the detecting means 4 form a spectroscopic inspection unit. Spectroscopy deals with the measurement and study of an electromagnetic spectrum. By way of an exemplary, non-limiting example, techniques of spectroscopy with absorption of UV/Vis, NIR or IR, Raman, fluorescence, etc., can be used.

Preferably, the spectroscopic inspection unit 3, 4 is located in a restricted zone along the transport path, for example, in a box-shaped casing.

In accordance with an implementation form, the spectroscopic inspection unit 3, 4 is movable along the transport means 2 such as to originate with the transport means 2 a chasing (or boomerang) inspection system of a known type.

In an alternative implementation form, the spectroscopic inspection unit 3, 4 is stationary, and the transport system takes the packages 100 to the position that is suitable for the measurement.

The inspection system 1 comprises a control unit 5 configured to perform a spectral analysis of the detected optical spectrum.

In particular, the control unit 5 communicates with the spectroscopic inspection unit 3, 4 to receive the detected spectrum in the form of data (the variables are, for example, intensities or ratios between intensities as a function of the wavelength or wavenumber).

The control unit 5 performs the spectral analysis in order to determine whether the pharmaceutical product contained in the package 100 is compliant or non-compliant with respect to a predefined criterion.

The compliance depends on the type of product that is analysed and on the pollutants. For example, a product is considered as compliant when it responds, in terms of concentration of active ingredient and pollutants, and in particular also of excipients, to the maximum and minimum values required by the Pharmacopoeia or by other standards, dictated by the medicines agencies.

In practice, by the present method and system, the entire and complete composition of the pharmaceutical product, and preferably of the solution containing the drug or the pharmaceutical product liquid is identified, and in particular it is verified whether this is compliant or non-compliant with a predefined criterion.

In particular by the present method and system, the active ingredient is identified, or possibly the active ingredients, the concentration of the same active ingredient, i.e., of the same active ingredients, and the concentration of the excipient, or excipients, and the concentration of any pollutants or impurities that are present in the same pharmaceutical product, in particular that are present in the solution containing the drug, i.e., in the liquid pharmaceutical product, are identified.

In accordance with a first implementation form, the control unit 5 is configured to compare the detected optical spectrum with a reference optical spectrum. The reference optical spectrum is an optical spectrum generated by a product considered as compliant. In particular, the control unit 5 comprises means for comparing 6 the detected optical spectrum with a reference spectrum.

In accordance with an implementation form, the control unit 5 is configured to process the detected optical spectrum by subdividing it into a predefined number of subsets. The comparing means 6 carry out a comparison for at least one plurality of intensities of the spectrum in at least one subset of ranges of wavelengths with a range of values obtained from a standard spectrum.

Preferably, the comparison is carried out within the entire range of wavelengths at which the acquisition occurred.

In accordance with an implementation form, the control unit 5 is operatively connected to the transport means 2, the source 3, and/or the detecting means 4.

In accordance with an implementation form, the control unit 5 only oversees the analysis of the detected optical spectrum. One or more control units in communication with the control unit 5 are operatively connected to the transport means 2, the source 3, and the detecting means 4.

In accordance with a second implementation form, the control unit 5 is configured to process the detected optical spectrum by means of a technique based on Principal Components Analysis (PCA), which technique is also known as the Karhunen-Loève transform.

This technique aims to reduce the size of the data of the detected optical spectrum (i.e., the data set) to be analysed, by identifying the so-called Principal Components (CP). This takes place via a linear transformation of the variables, which project the original ones to a new Cartesian system where the new variable with the highest variance is projected onto the first axis, the new variable that is second in extent by variance on the second axis, and so on.

In particular, the control unit 5 is configured to obtain a plurality of variables, so-called principal components, starting from a series of spectra on known compliant and non-compliant samples (in the “training” step, which is best described herein below); the training starts from calculating a covariance matrix of the data of the detected optical spectra and of its eigenvectors and eigenvalues.

Preferably, a calculation of the covariance matrix occurs as described herein below: given a population of n elements, measured spectra in this case, on which k quantitative characters are detected, in this case the number of the points corresponding to the sampled wavelengths per spectrum, we denote by Xₕᵢ the point i of the spectrum h (i=1, 2, . . . , k; h=1, 2, . . . , n); the covariance matrix has a dimension k×k, and each element thereof is defined by:

$${σ}_{ij}^{2} = \frac{1}{n} {\sum }_{h = 1}^{n} ( {x}_{hi} - {μ}_{i} ) ( {x}_{hj} - {μ}_{j} ) ,$$

where μi is the average of Xₕᵢ on the spectra h.

Preferably, the control unit 5 is configured to normalize the data of the detected optical spectrum so as to bring the values to a conventional range (specific of the measurement technique used). This takes place before calculating the covariance matrix.

By the sake of completeness, the concepts of eigenvalues and eigenvectors of a matrix are set forth herein below: Let A be a square matrix of order n with coefficients in the field K, where K can be represented by the set of real numbers R or complex numbers C, it is defined that the scalar λ₀ is an eigenvalue of the matrix A if there exists a nonzero column vector v belonging to the field K of order n such that Av=λ_{0V}.

The vector v of the above equation is called the eigenvector relative to the eigenvalue λ₀.

The eigenvectors of the covariance matrix, ordered by decreasing eigenvalues, correspond to a base onto which, for any spectrum, the principal components are to be calculated (i.e., the coefficients on this base) the control unit 5 is further configured to select a first subset of principal components. The number of selected principal components varies based on the type of detected optical spectrum (i.e., based on the spectroscopy technique that is used), the tool that is used to determine the compliance (which will be detailed herein below), and the desired confidence level. The first subset is determined empirically: a plurality of tests with a different number of selected principal components is performed to identify the number required to achieve the desired confidence level (e.g., LC 99). The selected number of principal components usually ranges between 2 and 5. In fact, the reduction of the complexity is due to the restriction to analyse the principal ones, by variance, among the new variables (the principal components).

Subsequently, the control unit 5 is configured to reprocess the data of the detected optical spectrum according to the selected principal components.

In particular, processing of the detected data takes place via a processor PCA 7 of the control unit 5.

Preferably, the control unit 5 is configured to feed the reprocessed data of the detected optical spectrum to a classifier 8 trained to classify the data as compliant or non-compliant.

In the preferred implementation form, the classifier 8 is a neural network. In accordance with the present invention, the neural network used by the inspection system 1 needs to be trained by using a training process. Such training process of the neural network can be done by the user by using the same detecting means described above. For such training process, a training set composed of a plurality of products can be used. The training set can be partitioned so as to comprise a first class of products, for example 70%, which are non-compliant with a given reference standard/guideline, and, for example 30%, which are compliant with the reference standard. Once it has been trained, the neural network is used by inference in the inspection system, and it receives in input the principal components of a signal relative to the package 100 and classifies it as compliant/non-compliant.

For further details on the process for training an artificial intelligence, reference can be made to the Italian patent application No. 102021000007718.

It is possible to provide for the use of any artificial intelligence technique based on algorithms for training Neural Networks, among which, for example, Deep Learning Neural Network, CNN (Cellular/Convolutional Neural Networks) architectures, Gaussian Classifier, Logistic Regression, Support Vector Machine. Such technological systems, suitably trained beforehand to recognize spectra of packages compliant with the placing on the market, and spectra of packages non-compliant with the placing on the market, will be able to discern, by analysing the collected spectrum, the compliance of the analysed package 100 and, possibly, to quantify the compounds contained therein and/or the concentration thereof.

By artificial intelligence techniques, are meant all those techniques that allow making algorithms/architectures and software/hardware which can be trained to recognize a particular type of datum, and to classify it as such.

By way of example, a brief description of a possible implementation model relating to the use of a neural network is set forth below. The neural network developed for this example consists of 80 convolutional layers of computational knots (referred to as neurons), followed by 10 layers of locally connected neurons. Each layer of neurons has dimensions that are equal to those of the analysed spectra (such that a characteristic derivative based on the Principal Components Analysis corresponds to each neuron). The neural network can identify, within the processed spectrum, the presence of any non-compliances in the analysed product. For example, the neural network can output a binary value where “0” denotes a non-compliance of the product, while “1” denotes the product compliance.

Some application examples of the identification system 1 described above are set forth herein below.

In a first example, consider the analysis of a bottle containing a solution of paracetamol, analysed by the spectroscopic technique that uses the Raman effect. In this particular case, it was chosen to use, as the source, 3 a laser with a 785 nm wavelength, a detector 4 comprising a lens, an optical fibre system, and a spectrometer equipped with a diffraction grating, and a CCD video camera, and/or in particular with a photodiode; the control unit 5 comprises an artificial intelligence algorithm of the CNN type, trained to recognize the spectra of samples of Paracetamol 1 g/bottle 100 ml compliant with the standards, to derive the concentration of the expected compounds contained therein, and possibly to detect the presence of unexpected impurities that may cause a detectable Raman signal.

In a second example, consider the analysis of a blister of Diclofenac tablets, which is analysed by the spectroscopic technique that uses an absorption effect. In this particular, non-limiting case, it was chosen to use an infrared source 3, possibly up to the Terahertz region. Additionally, a spectrum analyser (spectrophotometer, or FTIR) and an artificial intelligence algorithm of the Machine Learning type, which was trained to recognize the spectra of the samples of Diclofenac in 100 mg/cp tablets and to derive the concentration of the compounds contained therein were further used.

Preferably, the identification system 1 comprises discard means 9 of at least a product identified as non-compliant, downstream of the inspection unit 3, 4 along the transport path. The discard means 9 receive information on the non-compliance of a package 100 from the control unit 5.

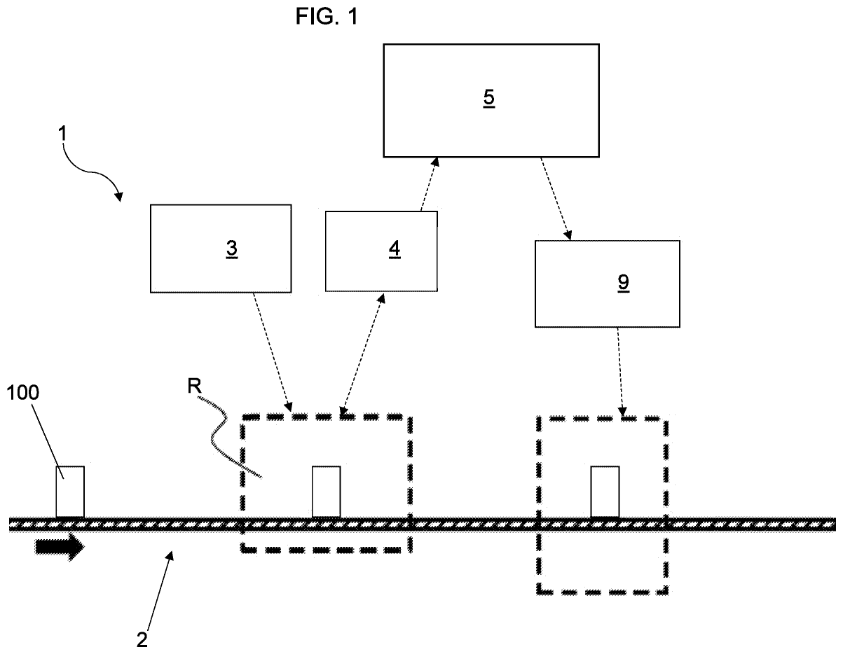

The discard means 9 can comprise signalling means to signal the detection of a non-compliant product, such as, for example, acoustic and/or visual signalling devices, and actuator means to convey at least one non-compliant product to a discharge zone, not shown in FIG. 1. The actuator means can comprise servomechanisms actuated by electrical motors and/or hydraulic systems.

Additionally or alternatively, the discard means 9 can comprise robotic gripping means.

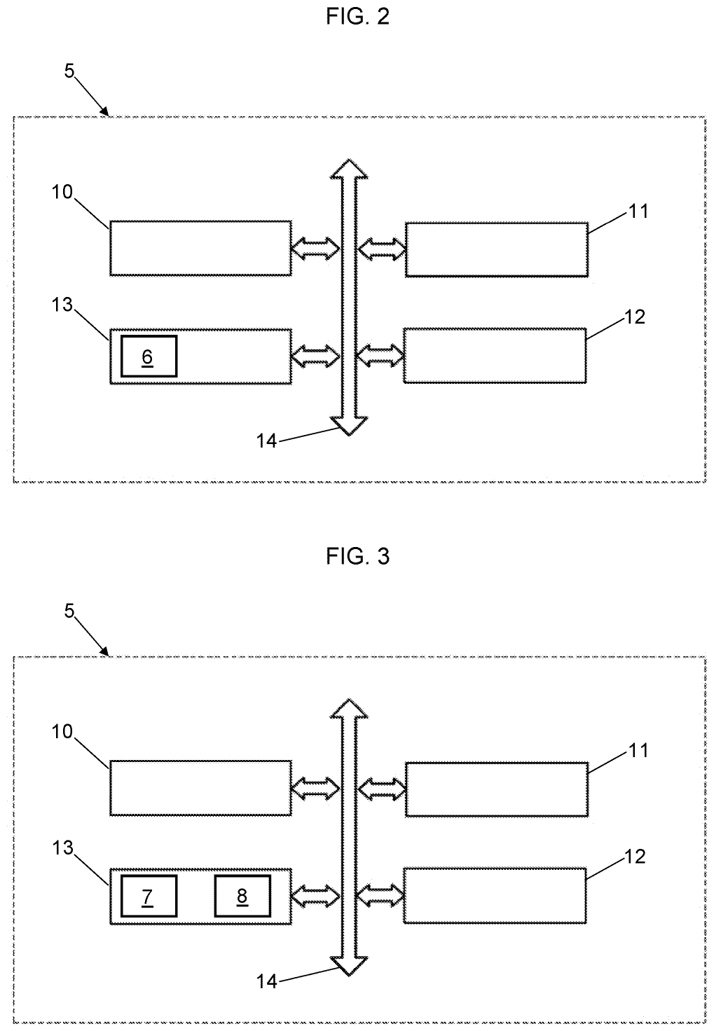

FIG. 2 illustrates an exemplary block diagram of the control unit 5. The control unit 5 should not be strictly understood as a single physical block located in space, but also as a set of cooperating control units and devices.

The control unit 5 can comprise interface means 10, communication means 11, storage means 12, and processing means 13 which can be operatively interconnected to one another through a communication bus 14.

The interface means 10 are adapted to manage at least the transport means 2, the source 3, and the acquisition means 4. The interface means 10 can for example comprise electronic apparatuses to drive the servomechanisms actuated by the electrical motors and/or the hydraulic systems encompassed in the transport means 2 or the devices 3, 4. The interface means 10 can comprise, for example, sensor means such as, for example, accelerometers, photocells, RFID sensors, video cameras, and so on, to detect the presence of the product in the inspection region R.

The communication means 11 are adapted to emit in output from the identification system 1 information obtained with the analysis of the pharmaceutical product. The communication means 11 can for example comprise a communication unit adapted to communicate with a managing system and/or a remote server. Said communication unit can for example comprise an ETHERNET interface, a WiFi interface, a GSM interface, UMTS, LTE, 5G, and so on. The communication unit can make a connection to an outer apparatus for managing or monitoring the identification system 1, such as, for example, a processor, a smartphone, a tablet, and so on. The communication means 11 can allow a user to interact with the identification system 1. For example, the communication means 11 can comprise output and input means, such as, for example, a display and an alphanumeric keyboard, respectively, or alternatively, a touchscreen display in which an alphanumeric keyboard and interactive symbols are displayed. In another embodiment of the invention, the communication means 11 can comprise a port for communicating with a terminal that is outside the identification system 1, such as, for example a RS232 interface, USB, and so on. The terminal outside the identification system 1 can be for example a smartphone controlled by the user.

The storage means 12 allow storing the input and/or output information of the identification system 1. The storage means 12 can comprise, for example, a solid-state flash type memory. The information can comprise a set of values and/or parameters useful for carrying out the analysis of the spectrum, that is the object of the present invention. Such information can further comprise a set of those parameters characterizing a neural network which is suitably trained for recognizing non-compliant products.

The processing means 13 process the information and instructions stored in the storage means 12 and/or received from said interface means 10 and said communication means 11, and can comprise, for example, an ARM-type processor, an Arduino-type microcontroller, a processor with x86, x64 architecture, and so on.

The processing means 13 comprise the comparing means 6. In the second implementation form, the processing means 13 comprise the computer PCA 7 and the classifier 8.

A method for inspecting a pharmaceutical product contained in a package, according to the present invention, is described below. Such a method is advantageously implemented by an inspection system 1 according to what has been described above.

The inspection method comprises a step of advancing a package 100 with the pharmaceutical product along a transport path.

Preferably, the advancement occurs by means of transport means 2 as described above.

The inspection method comprises a step of subjecting the pharmaceutical product to at least one electromagnetic radiation emitted towards the package 100 and a step of detecting an optical spectrum generated in response to the impact of the electromagnetic radiation on the pharmaceutical product. Such steps occur during the advancement of the package 100 along the transport path. Such steps constitute an inspection step of the pharmaceutical product. In particular, the inspection occurs by optical spectroscopy.

Preferably, the electromagnetic radiation has a wavelength within the band between the ultraviolet and infrared, up to the Terahertz.

The inspection method comprises a step of performing a spectral analysis of the detected optical spectrum in order to determine whether the pharmaceutical product contained in the package 100 is compliant or non-compliant with respect to a predefined criterion. The compliance depends on the type of product that is analysed and on the pollutants. For example, a product is considered as compliant when it responds, in terms of concentration of active ingredient and pollutants, and in particular also of excipients, to the maximum and minimum values required by the Pharmacopoeia or by other standards, dictated by the medicines agencies.

In accordance with a first implementation form of the method, the spectral analysis step comprises a step of comparing the detected optical spectrum with a reference spectrum. The reference optical spectrum is an optical spectrum generated by a product that is considered as compliant.

Preferably, the spectral analysis step comprises a step of processing the detected optical spectrum by subdividing it into a predefined number of subsets. The comparison occurs for at least one plurality of intensities of the spectrum in at least one subset of ranges of wavelengths with a range of values obtained from a standard spectrum. Preferably, the comparison is carried out within the entire range of wavelengths at which the acquisition occurred.

In accordance with a second implementation form of the method, the spectral analysis step comprises a step of processing the detected optical spectrum by means of a technique based on the Principal components Analysis of the signal. For further details on this technique, see what has been previously described with regard thereto.

The step of processing the detected optical spectrum comprises a step of obtaining a plurality of variables, so-called principal components, with an algorithm obtained by calculating a covariance matrix of the data of optical spectra detected in a training step and of its eigenvectors and eigenvalues. For further details about the calculation of the principal components, see what has been previously described with regard thereto.

Preferably, prior to the calculation of the principal components, a step of normalizing the data of the detected optical spectrum is performed, so as to bring the values back to within a conventional range (which is specific according to the measurement technique used).

Next, the step of processing the detected optical spectrum comprises a step of selecting a first subset of principal components. In other words, a restricted number of principal components, lower than the starting one, is selected.

The selected number of principal components changes based on the type of detected optical spectrum (i.e., based on the spectroscopy technique that is used), the tool that is used to determine the compliance (see below), and the desired confidence level. Such number is determined empirically. The selected number of principal components usually ranges between 2 and 5.

The step of processing the detected optical spectrum further comprises a step of reprocessing the data of the detected optical spectrum according to the principal components of the first subset.

In particular, the above-mentioned processing steps are performed by a computer PCA 7 of the control unit 5.

The method comprises a step of feeding the reprocessed data to a classifier 8, which is trained to classify the data as compliant or non-compliant.

In accordance with the present invention, the neural network used by the inspection system 1 needs to be trained by using a training process. Such training process of the neural network can be done by the user by using the same detecting means described above. For such training process, a training set composed of a plurality of products can be used. The training set can be partitioned so as to comprise a first class of products, for example 70%, which are non-compliant with a given reference standard/guideline, and, for example 30%, which are compliant with the reference standard. Once the neural network has been trained, it is used by inference in the inspection system, and it receives in input the principal components of a signal relative to the package 100 and classifies it as being compliant/non-compliant.

For further details on the process of training an artificial intelligence, reference can be made to the Italian patent application No. 102021000007718.

It is possible to provide for the use of any of artificial intelligence techniques based on training algoritms for Neural Networks, among which, for example, Deep Learning Neural Network, CNN (Cellular/Convolutional Neural Networks) architectures, Gaussian Classifier, Logistic Regression, Support Vector Machine. Such technological systems, which are previously suitably trained to recognize spectra of packages that are compliant with the placing on the market, and spectra of packages that are non-compliant with the placing on the market, will be able to discern, by analysing the collected spectrum, the compliance of the analysed package 100 and, possibly, to quantify the compounds contained therein and/or the concentration thereof.

By artificial intelligence techniques, are meant all those techniques that allow making algorithms/architectures and software/hardware that can be trained to recognize a particular type of datum and to classify it as such.

From the above description, the characteristics of the method and system for inspecting a pharmaceutical product contained in a package according to the present invention are apparent, as apparent are the advantages thereof.

In particular, the method and system proposed herein allow a non-invasive control of the quality. Furthermore, the use of spectroscopy to analyse the pharmaceutical product potentially allows to analyse every single package within a significantly less time compared to the known solutions.

The implementation form which takes advantage of the Principal Components Analysis to process the data prior to the classification allows operating a compliance control that is rapid, yet accurate. In fact, by reprocessing the data based on said described technique, the differences between a compliant and a non-compliant product are better outlined. The principal components to be selected vary according to the pharmaceutical product to be inspected, and the selected classifier.

The use of a suitably trained neural network reduces the processing times. Furthermore, the more data are collected and fed for training the artificial intelligence (even during the operational functioning), the more the accuracy in the analysis, and the less the risk of false positives will be.

In practice, from what has been set forth above, it is understood that the spectral analysis step comprises a step of comparing the detected optical spectrum with a reference spectrum.

Furthermore, from what has been set forth above, it is understood that the spectral analysis step employs a classifier, in particular in the form of a neural network, trained to classify the received data as compliant or non-compliant with respect to a predefined criterion.

Additionally, from what has been set forth above, it is understood that the training set is partitioned so as to comprise products that are non-compliant with a given reference standard/guideline, and products that are compliant with the reference standard.

From what has been set forth above, is can also be understood that a product is considered as compliant when it responds, in terms of concentration of active ingredient and pollutants, and in particular also of the excipients, to the maximum and minimum values required by the Pharmacopoeia or by other standards, dictated by the medicines agencies.

Furthermore, from what has been set forth above, it is understood that said control unit 5 is configured to perform the spectral analysis in order to determine whether the pharmaceutical product contained in the package is compliant or non-compliant with respect to a predefined criterion.

Additionally, from what has been set forth above, it is understood that said control unit 5 employs a classifier, in particular in the form of a neural network, trained to classify said data as compliant or non-compliant with respect to a predefined criterion.

In practice, as is clear, the technical characteristics illustrated above allow, singularly or in a respective combination, achieving one or more of the following advantageous results:
At least potentially, it is possible to analyse every single package within a significantly less time compared to the known solutions;
A quality control of a non-invasive type can be obtained;
A high degree of reliability in assessing the compliance of the pharmaceutical product can be obtained;
An inspection of a pharmaceutical product contained in a package can be operated on any pharmaceutical product without having to make substantial modifications.

The present invention is susceptible of a clear industrial application. Those skilled in the art will be further able to devise a number of modifications and/or variations to be made to the same invention, while remaining within the scope of the innovative concept, as broadly set forth. Furthermore, those skilled in the art will be able to devise further preferred implementations of the finding that comprise one or more of the characteristics illustrated above of the preferred implementation, in particular as set forth in the attached claims. Furthermore, it is also to be understood that all the details of the invention can be replaced by technically equivalent elements.

1. A method for inspecting a pharmaceutical product contained in a package, preferably in the form of a solution containing the drug, in particular contained in a corresponding bottle, said method comprising the steps of:
advancing a package of said pharmaceutical product along a transport path;
during the advancement of the package along the transport path, subjecting the pharmaceutical product to at least one electromagnetic radiation emitted towards the package and detecting an optical spectrum generated in response to the impact of the electromagnetic radiation on the pharmaceutical product;
performing a spectral analysis of the detected optical spectrum.

2. The inspection method according to claim 1, wherein the spectral analysis step comprises a step of processing the detected optical spectrum by means of a Principal Component Analysis technique.

3. The inspection method according to claim 2, wherein the step of processing the detected optical spectrum comprises the following steps:
obtaining a plurality of variables, so-called principal components, by calculating a covariance matrix of the data of the detected optical spectrum and of its eigenvectors and eigenvalues;
selecting a first subset of principal components;
reprocessing the data of the detected optical spectrum according to the principal components of the first subset.

4. The inspection method according to claim 3, wherein the spectral analysis step comprises a step of feeding the reprocessed data of the detected optical spectrum to a trained classifier to classify said data as compliant or non-compliant with respect to a predefined criterion.

5. The inspection method according to claim 4, wherein said classifier comprises a neural network.

6. The inspection method according to claim 1, wherein the spectral analysis step comprises a step of comparing the detected optical spectrum with a reference spectrum.

7. The inspection method according to claim 6, wherein the spectral analysis step employs a classifier, in particular in the form of a neural network, trained to classify the detected data as compliant or non-compliant with respect to a predefined criterion.

8. The inspection method according to claim 7, wherein the training set is partitioned so as to comprise products that are non-compliant with a given reference standard/guideline, and products that are compliant with the reference standard.

9. The inspection method according to claim 7, wherein a product is considered as compliant when it responds, in terms of concentration of active ingredient and pollutants, and in particular also of the excipients, to the maximum and minimum values required by the Pharmacopoeia or by other standards, dictated by the medicines agencies.

10. A system for inspecting a pharmaceutical product contained in a package, preferably in the form of a solution containing the drug, in particular contained in a corresponding bottle, said inspection system-comprising:
means for transporting at least one package with said pharmaceutical product therein along a transport path;
a source of electromagnetic radiations configured to emit at least one electromagnetic radiation towards the pharmaceutical product contained in the package arranged in a control station, said control station being located along the transport path; means for detecting an optical spectrum generated in response to the impact of the electromagnetic radiation on the pharmaceutical product; a control unit configured to perform a spectral analysis of the detected optical spectrum.

11. The inspection system according to claim 10, wherein the control unit is configured to process the detected optical spectrum by means of a Principal Component Analysis technique.

12. The inspection system according to claim 11, wherein the control unit is configured to:
obtain a plurality of variables, so-called principal components, by calculating a covariance matrix of the data of the detected optical spectrum and of its eigenvectors and eigenvalues;
select a first subset of principal components;
reprocess the data of the detected optical spectrum according to the selected principal components;
feed the reprocessed data of the detected optical spectrum to a trained classifier to classify said data as compliant or non-compliant with respect to a predefined criterion.

13. The inspection system according to claim 10, wherein said control unit is configured to compare the detected optical spectrum with a reference spectrum.

14. The inspection system according to claim 10, wherein said control unit is configured to perform the spectral analysis in order to determine whether the pharmaceutical product contained in the package is compliant or non-compliant with respect to a predefined criterion.

15. The inspection system according to claim 14, wherein said control unit employs a classifier, in particular in the form of a neural network, which is trained to classify said data as compliant or non-compliant with respect to a predefined criterion.

16. The inspection system according to claim 15, wherein the training set is partitioned so as to comprise products that are non-compliant with a given reference standard/guideline, and products that are compliant with the reference standard.

17. The inspection system according to claim 15, wherein a product is considered as compliant when it responds, in terms of concentration of active ingredient and pollutants, and in particular also of the excipients, to the maximum and minimum values required by the Pharmacopoeia or by other standards, dictated by the medicines agencies.
